(19) United States
(12) Patent Application Publication
(10) Pub. No.: US 2005/0241087 A1
(43) Pub. Date: Nov. 3, 2005

(54) Cleaning device for a substrate

(75) Inventor: Shih-Min Wu, Taipei (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Arima Display Corp., Taipei (TW)

(21) Appl. No.: 10/837,055

(22) Filed: Apr. 30, 2004

(51) Int. Cl. B08B 1/00

(52) U.S. Cl. 15/102

(57) ABSTRACT

A cleaning device for cleaning a verge of a substrate by using a cleaning agent, includes a supporting structure and an absorber connected to the supporting structure. The substrate is cleaned by means of a contacting and a relative movement between the absorber and the substrate.

### FIELD OF THE INVENTION

The present invention is related to a cleaning device, in particular, to a cleaning device used to clean a LCD (Liquid Crystal Display) panel.

### BACKGROUND OF THE INVENTION

With an improvement of the manufacturing process technology, the LCD (Liquid Crystal Display) has been a broadly practiced display device. The adopted principle is that the arrangement of the LC molecule is controlled by an applied electric field when a light from a back light source passes through the LC molecules and thereby a shade variation of brightness and lightness is displayed on the screen.

A lithography processing is always involved in the manufacture of a LCD to form a pattern on the photoresist coated on a LC substrate. The lithography processing includes the following steps: a LC substrate cleaning, a LC substrate drying, a photoresist coating and a photoresist pattern forming.

Please refer to FIG. 1, which illustrates the conventional structure of the photoresist coating on the LCD panel according to the prior art. A layer of photoresist 11 is coated on a substrate 10 and there exsits a non-uniform photoresist coating 12 on the verge of the substrate 10 because of a surface tension. This non-uniform photoresist coating 12 seriously affects the process afterward and the production yield of the LCD processing. In order to solve such a problem, several improved methods are disclosed in the prior art: the immersing method, the spraying method and the blowing method.

Please refer to FIG. 2, which illustrates the immersing method according to the prior art. A clamping apparatus 20 is used to clamp a substrate 21 in this method. The four edges of the substrate 21 are orderly immersed into a cleaning agent 23 in a container 22 to clean and remove the non-uniform photoresist coating 24 on the verge of the substrate 21. However, because of the repeated use of the cleaning agent 23 in the container 22, the quality of the substrate cleaning is more and more difficult to be maintained after the increasing amount of substrates 21 is cleaned. As a result, a producing cost is getting much more while increasing the cleaning agent exchanging times for improving the cleaning quality.

Please refer to FIG. 3, which illustrates the spraying method according to the U.S. Pat. No. 6,062,288. In this method, a movable spraying device 30 is used to spray the cleaning agent to the four edges of the substrate 31 to clean and remove the non-uniform photoresist coating on the verge of the substrate 31. However, the spraying range of the spraying device 30 is not easy to be controlled. Hence the photoresist patterns at the nearly inside the verge of the substrate 31 will be easily destroyed by the cleaning agent while the non-uniform photoresist coating on the verge is cleaned. In other words, the photoresist pattern is not intact after the non-uniform photoresist is removed.

Please refer to FIG. 4, which illustrates the blowing method according to the prior art. A cleaning device related to an air-knife is used in this method to overcome the drawback of the spraying method described above. As shown in FIG. 4, an air-knife 41 is installed in a spraying device 40 and the cleaning agent sprayed from the spraying device 40 will be restricted within a specific range by the gas blew form the air-knife 41 to prevent the photoresist pattern destruction by the spraying cleaning agent. In a microcosmic view, however, the pressure distribution of the gas blew from the air-knife 41 is non-uniform while the gas contacts with the photoresist 42 and this still results in a non-uniform coating of the photoresist 42. Moreover, when an extremely small distance exists between the air-knife 41 and the substrate 44, a vacuum state will be formed at the gas-contacting location of the photoresist 42. Therefore, the substrate 44 will be sucked by the air-knife 41 and this results in a breakage of the substrate 44.

In order to overcome the drawbacks in the prior art, a cleaning device, in particular, a cleaning device for cleaning a verge of a substrate is provided.

### SUMMARY OF THE INVENTION

The main purpose of the present invention is to provide a cleaning device. An absorber having the properties of porosity and high structural density is used for absorbing a cleaning agent to clean the verge of a substrate and control the flow rate of the cleaning agent, the thickness of the coating on the substrate, the cleaning area and the pressure and stability while cleaning.

According to one aspect of the present invention, a cleaning device for cleaning a verge of a substrate by using a cleaning agent, includes a supporting structure and an absorber connected to the supporting structure, wherein the cleaning agent is absorbed by the absorber and the verge of the substrate is cleaned by a contacting and a relative movement between the absorber and the substrate.

In accordance with the present invention, the cleaning device moves in a plane parallel to the substrate to control a relative position between the absorber and the substrate.

Preferably, a type of the cleaning agent is corresponding to a material of the absorber.

Preferably, the cleaning agent is absorbed by the absorber through an injection of a pinhead.

Preferably, the substrate is a silicon substrate.

Preferably, the cleaning device is used to clean a photoresist coating on the verge of the substrate.

Preferably, the supporting structure further includes a flexing device to control the contacting of the absorber with the substrate while the absorber moves in a plane perpendicular to the substrate.

Preferably, the flexing device is a spring.

Preferably, the supporting structure further includes a bearing for being sleeved by the absorber.

Preferably, the substrate is fixed on a moving device and the moving device moves in a plane parallel to the substrate to control the contacting and the relative movement between the absorber and the substrate.

Preferably, the moving device further includes a base fixed on the substrate, a spin motor connected to the base and a rectilinear motor connected to the spin motor. The base moves in a plane parallel to the substrate by a cooperation of the spin motor and the rectilinear motor.

According to another aspect of the present invention, a cleaning device for cleaning a verge of a substrate by using an cleaning agent, includes a first supporting structure located at a side of the substrate, a first absorber connected to the first supporting structure, a second supporting structure located at another side of the substrate and a second absorber connected to the second supporting structure. The cleaning agent is absorbed by the first absorber and the second absorber and the verge of the substrate is cleaned by a contacting and a relative movement among the first and second absorbers and the substrate.

In accordance with the present invention, the cleaning device moves in a plane parallel to the substrate to respectively control a relative position among the first and second absorbers and the substrate.

Preferably, a type of the cleaning agent is corresponding to a material of the first and second absorbers.

Preferably, the cleaning agents are respectively absorbed by the first and second absorbers through an injection of a pinhead.

Preferably, the substrate is a silicon substrate.

Preferably, the cleaning device is used to clean a photoresistance coating on the verge of the substrate.

Preferably, the first supporting structure and the second supporting structure further respectively include a first flexing device and a second flexing device to respectively control the contacting of the first and second absorbers with the substrate while the first and second absorbers move in a plane perpendicular to the substrate.

Preferably, the first and the second flexing devices are springs.

Preferably, the first and the second supporting structures further include a bearing for being sleeved by the absorber.

Preferably, the substrate is fixed on a moving device and the moving device moves in a plane parallel to the substrate to respectively control the contacting and the relative movement between the first and second absorbers and the substrate.

Preferably, the moving device further includes a base fixed on the substrate, a spin motor connected to the base and a rectilinear motor connected to the spin motor. The base moves in a plane parallel to the substrate by a cooperation of the spin motor and the rectilinear motor.

The foregoing and other features and advantages of the present invention will be more clearly understood through the following descriptions with reference to the drawings, wherein:

### BRIEF DESCRIPTION OF THE DRAWINGS

FIG. 1 is a diagram illustrating the conventional structure of the photoresist coating on the LCD panel according to the prior art;

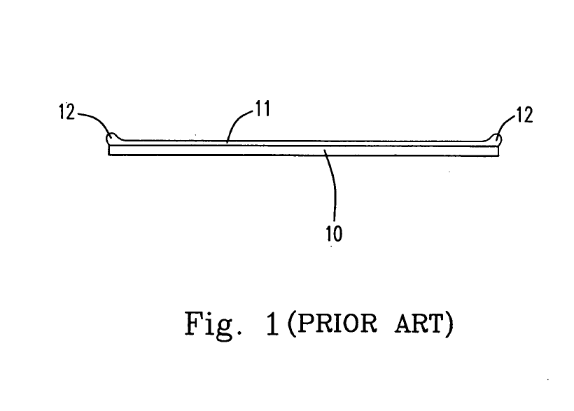

FIG. 2 is a diagram illustrating the immersing method according to the prior art;

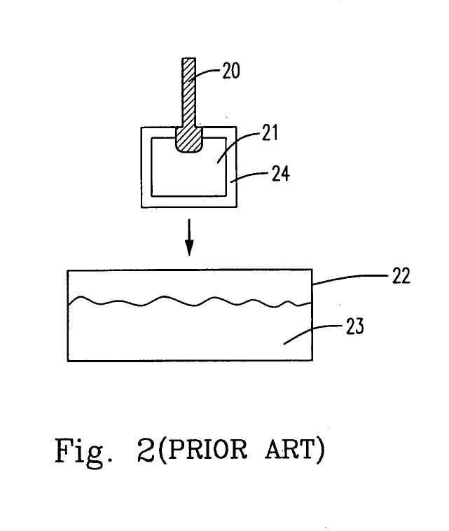

FIG. 3 is a diagram illustrating the spraying method according to the prior art;

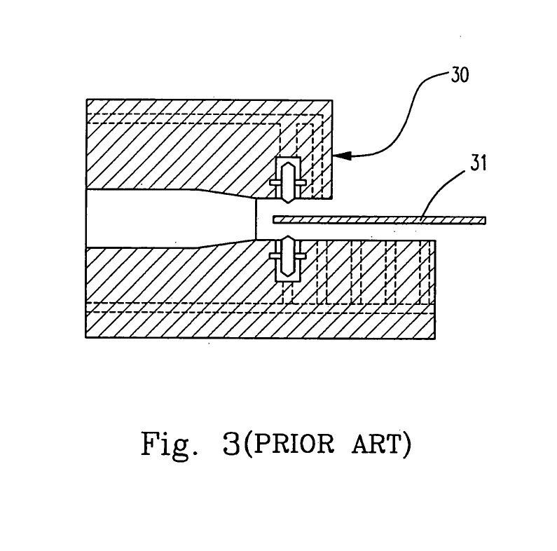

FIG. 4 is a diagram illustrating the blowing method according to the prior art;

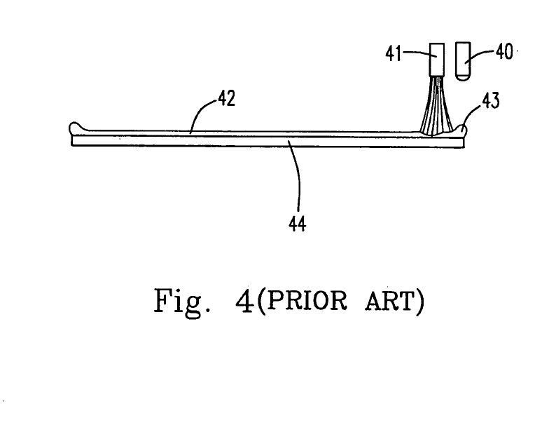

FIG. 5 is a side view illustrating the structure of the cleaning device according to a preferred embodiment of the present invention;

FIG. 6 is a side view illustrating the structure of the moving device according to a preferred embodiment of the present invention; and

FIG. 7 is a side view illustrating the structure of the cleaning device according to another preferred embodiment of the present invention,

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

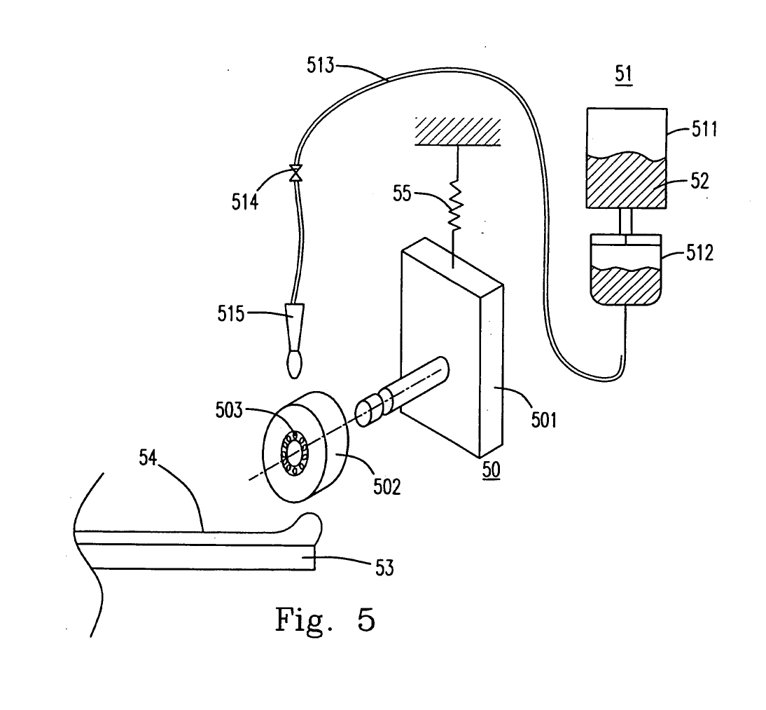

Please refer to FIG. 5. FIG. 5 is a side view illustrating the structure of the cleaning device according to a preferred embodiment of the present invention. The cleaning device 50 includes a supporting structure 501 and a sponge 502 connected to the supporting structure 501. After a cleaning agent 52 is injected into the sponge 502 by an injecting device 51, the cleaning device 50 is able to clean a substrate 53 and a photoresist coating 54 thereon by a contacting and a relative movement between the sponge 502 and the substrate 53.

As shown in FIG. 5, the substrate 53 is a silicon substrate and the supporting structure 501 further includes a bearing 503 for being sleeved by the sponge 502. The injecting device 51 includes a container 511, a buffering container 512 connected to the container 511, a connecting tube 513, a controlling valve 514 connected to the buffering container 512 and a pinhead 515 on the injecting end of the connecting tube 513. The amounts, volume and flux rate of the cleaning agent 52 injected into the sponge 502 through the pinhead 515 are controlled by the controlling valve 514.

Additionally, the type of the cleaning agent 52 is corresponding to the material of the photoresist 54. Therefore, a various type of the sponge 502 can be used when considering the acidity and alkalinity of the cleaning agent 52.

Furthermore, the supporting structure 501 is further connected to the flexing device 55 to make the sponge 502 move in a plane perpendicular to the substrate 53 and control the contacting between the sponge 502 and the substrate 53 by a expansion and a contraction of the flexing device 55. Preferably, the flexing device 55 is a spring.

A point more worthy to be mentioned is that the cleaning device 50 and the flexing device 55 is able to move in a plane parallel to the substrate 53 to control a relative position between the sponge 502 and the substrate 53 for the cleaning process.

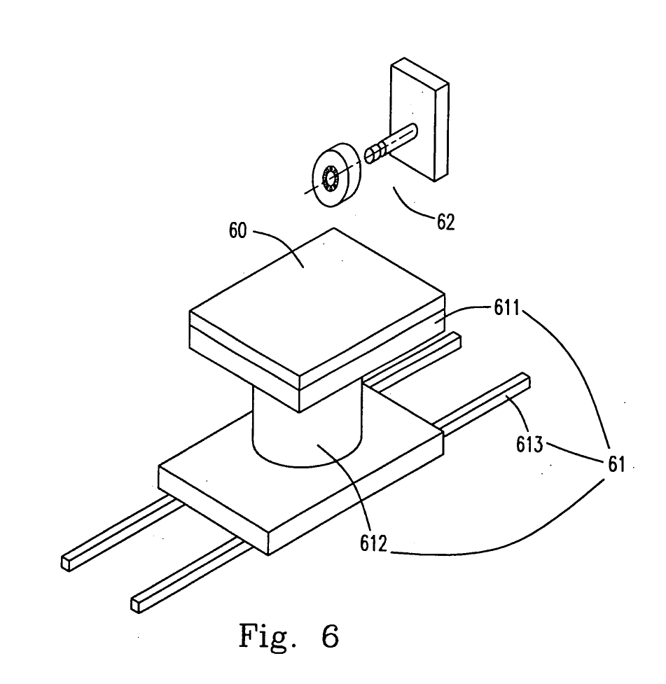

Please refer to FIG. 6, which is a side view illustrating the structure of the moving device according to a preferred embodiment of the present invention. The substrate 60 is fixed on the base 611 of the moving device 61. The moving device 61 further includes the spin motor 612 connected to the base 611 and the rectilinear motor 613 connected to the spin motor 612. By a cooperation of the spin motor 612 and the rectilinear motor 613, the moving device 61 carrying the substrate 60 moves in a plane parallel to the substrate 60 to control the relative position between the sponge 62 and the substrate 60 for the cleaning process.

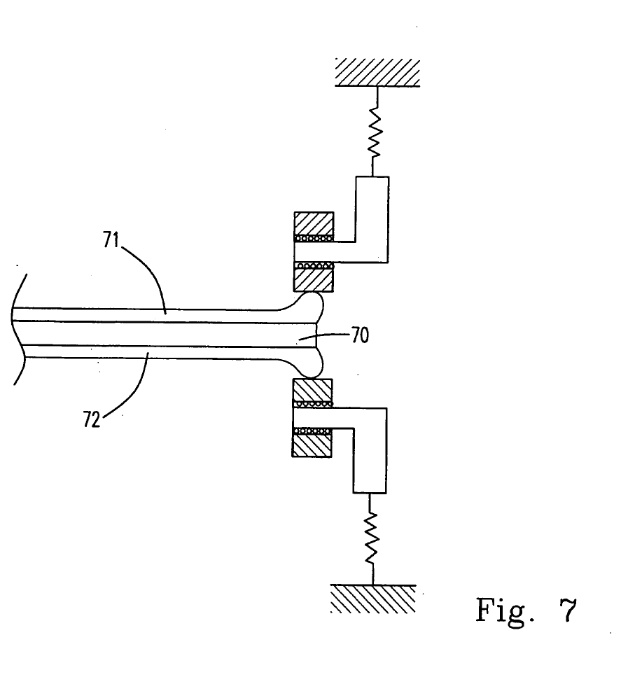

Besides, a pair of cleaning devices is installed to simultaneously and dividedly clean the both faces of a substrate 70 and the photoresists 71 and 72. Please refer to FIG. 7. Needless to say, all above restrictions are able to apply to the pair of cleaning device.

According to the above, the present invention provides a cleaning device having an absorber used for absorbing a cleaning agent to clean the verge of a substrate to control the flow rate of the cleaning agent, the thickness of a coating on the substrate, the cleaning area and the pressure and stability while cleaning. Because of the absorber having the properties of the porosity and the high structural density, the drawbacks of the conventional cleaning devices are overcome. Furthermore, the cleaning device provided in the present invention for cleaning the verge of a substrate has the following advantages:

A width controlling of the verge cleaning is more precise.

A linearity of the verge cleaning is improved.

The thickness of the cleaning agent used in the lithography processing is more controllable.

The pressure distribution of the both sides in the cleaning area is more coincidence.

The stability of the cleaning agent providing system is more superior.

The flux rate controlling of the cleaning agent is accurate.

A simultaneous cleaning is provided for the both faces of the substrate.

Hence, the present invention not only has a novelty and a progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A cleaning device for cleaning a verge of a substrate by using a cleaning agent, comprising:
a supporting structure; and
an absorber connected to said supporting structure;
wherein said cleaning agent is absorbed by said absorber and said verge of said substrate is cleaned by a contacting and a relative movement between said absorber and said substrate.

2. The cleaning device according to claim 1, wherein said cleaning device moves in a plane parallel to said substrate to control a relative position between said absorber and said substrate.

3. The cleaning device according to claim 1, wherein a type of said cleaning agent is corresponding to a material of said absorber.

4. The cleaning device according to claim 1, wherein said cleaning agent is absorbed by said absorber through an injection of a pinhead.

5. The cleaning device according to claim 1, wherein said substrate is a silicon substrate.

6. The cleaning device according to claim 1, wherein said absorber is a sponge.

7. The cleaning device according to claim 1, wherein said cleaning device is used to clean a photoresist coating on said verge of said substrate.

8. The cleaning device according to claim 1, wherein said supporting structure further comprises a flexing device to control said contacting of said absorber with said substrate while said absorber moves in a plane perpendicular to said substrate.

9. The cleaning device according to claim 8, wherein said flexing device is a spring.

10. The cleaning device according to claim 1, wherein said supporting structure further comprises a bearing for being sleeved by said absorber.

11. The cleaning device according to claim 1, wherein said substrate is fixed on a moving device and said moving device moves in a plane parallel to said substrate to control said contacting and said relative movement between said absorber and said substrate.

12. The cleaning device according to claim 11, wherein said moving device further comprises:
a base fixed on said substrate;
a spin motor connected to said base; and
a rectilinear motor connected to said spin motor;
wherein said base moves in a plane parallel to said substrate by a cooperation of said spin motor and said rectilinear motor.

13. A cleaning device for cleaning a verge of a substrate by using an cleaning agent, comprising:
a first supporting structure located at a side of said substrate;
a first absorber connected to said first supporting structure;
a second supporting structure located at another side of said substrate; and
a second absorber connected to said second supporting structure;
wherein said cleaning agent is absorbed by said first absorber and said second absorber and said verge of said substrate is cleaned by a contacting and a relative movement among said first and second absorbers and said substrate.

14. The cleaning device according to claim 13, wherein said cleaning device moves in a plane parallel to said substrate to respectively control a relative position among said first and second absorbers and said substrate.

15. The cleaning device according to claim 13, wherein said first supporting structure and said second supporting structure further respectively comprise a first flexing device and a second flexing device to respectively control said contacting of said first and second absorbers with said substrate while said first and second absorbers move in a plane perpendicular to said substrate.

16. The cleaning device according to claim 13, wherein said substrate is fixed on a moving device and said moving device moves in a plane parallel to said substrate to respectively control said contacting and said relative movement among said first and second absorbers and said substrate.

17. The cleaning device according to claim 13, wherein said moving device further comprises:
a base fixed on said substrate;
a spin motor connected to said base; and
a rectilinear motor connected to said spin motor;
wherein said base moves in a plane parallel to said substrate by a cooperation of said spin motor and said rectilinear motor.
